(19) United States
(12) Patent Application Publication
(10) Pub. No.: US 2006/0209315 A1
(43) Pub. Date: Sep. 21, 2006

(54) Device and method for identifying image forming print medium

(75) Inventor: Ho-Bin Hwang, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/360,467

(22) Filed: Feb. 24, 2006

(30) Foreign Application Priority Data
Mar. 5, 2005 (KR) 2005-0018436

(51) Int. Cl. G06F 3/12

(52) U.S. Cl. 358/1.1

(57) ABSTRACT

A device and method for identifying an image forming print medium are provided. The device includes a first light emitting unit which irradiates light onto the image forming print medium at a first incident angle, a second light emitting unit which irradiates light onto the image forming print medium at a second incident angle, a light receiving unit which receives light which is irradiated from the first light emitting unit and the second light emitting unit and reflected from the image forming print medium, an image forming print medium identifying unit which identifies the kind of the image forming print medium by using the variances of first received light amounts and second received light amounts which have varied over time, a light emission controlling unit which controls the light emissions of the first light emitting unit and the second light emitting unit.

### CROSS-REFERENCE TO RELATED APPLICATIONS

This application claims the benefit under 35 U.S.C. §119 (a) of a Korean patent application No. 10-2005-0018436, filed on Mar. 5, 2005, in the Korean Intellectual Property Office, the entire disclosure of which is hereby incorporated by reference.

### BACKGROUND OF THE INVENTION

1. Field of the Invention

The present invention relates to an image forming apparatus. More particularly, the present invention relates to a device and method for identifying an image forming print medium which identifies the kind of image forming print medium by using a light receiving element and a plurality of light emitting elements.

2. Description of the Related Art

An image forming apparatus such as a printer or a multifunctional device prints on general printing paper. However, in some cases, various transparent or glossy print media may be used, such as Overhead Projector (OHP) film and coated paper. Particularly, as digital cameras and camcorders have become popular, users want to directly print an image, and thus photographic paper is used as a print medium in the image forming apparatus. Thus, the image forming apparatus must establish an adequate printing condition according to the properties of the print medium, in order to provide desired resolution and image quality. A conventional image forming apparatus for determining the properties of various print media comprises a light emitting element for irradiating light onto the print medium at a predetermined angle of incidence, a first light receiving element which is installed at the same angle for measuring a degree of total reflection of the print medium, and a second light receiving element which is installed at right angles to the surface of the print medium for measuring the degree of diffused reflection of the print medium. The conventional image forming apparatus identifies the kind of print medium by the degree of total reflection by using the first light receiving element and the degree of diffused reflection by using the second light receiving element.

Here, the light emitting element, such as a light emitting diode (LED), is inexpensive. However, since the light receiving element, which receives light reflected from the print medium and converts the light into an electrical signal, is more expensive than the light emitting element, the cost of manufacturing the image forming apparatus increases.

Further, conventionally, since the amounts of light received by the light receiving elements are simply compared in the conventional apparatus, the kind of print medium can not be accurately identified. That is, normal paper and inkjet paper can not be accurately identified.

### SUMMARY OF THE INVENTION

The present invention is to provide a device which can accurately identify the kind of an image forming print medium used in an image forming apparatus.

The present invention is also to provide a method of accurately identifying the kind of an image forming print medium used in an image forming apparatus.

According to an aspect of the present invention, a device for identifying an image forming print medium is provided. The device comprises a first light emitting unit for irradiating light onto the image forming print medium at a first incident angle, a second light emitting unit for irradiating light onto the image forming print medium at a second incident angle, a light receiving unit for receiving the light irradiated from the first light emitting unit and the second light emitting unit and reflected from the image forming print medium, an image forming print medium identifying unit for identifying the kind of the image forming print medium by using the variances of first received light amounts and second received light amounts which have varied over time and are received in the light receiving unit, and a light emission controlling unit for controlling the light emission of the first light emitting unit and the second light emitting unit.

According to another aspect of the present invention, a method of identifying an image forming print medium is provided. The method comprises irradiating light onto the image forming print medium at a first incident angle and a second incident angle and receiving the light reflected from the image forming print medium, and identifying the kind of image forming print medium by using the variances of the first light receiving amounts and the second light receiving amounts.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a device for identifying an image forming print medium according to an exemplary embodiment of the present invention;

FIG. 2 is a diagram illustrating an angle between a first light emitting unit, a second light emitting element or a light receiving element shown in FIG. 1, and the surface of the image forming print medium according to an exemplary embodiment of the present invention;

FIG. 3 is a schematic diagram illustrating the amount of light received by the light receiving unit for a predetermined duration according to an exemplary embodiment of the present invention;

FIG. 4 is a block diagram 150 illustrating an image forming print medium identifying unit shown in FIG. 1 according to an exemplary embodiment of the present invention;

FIG. 5 illustrates various kinds of image forming print media identified by a first identifying unit shown in FIG. 4 according to an exemplary embodiment of the present invention;

FIG. 6 illustrates kinds of image forming print medium identified by a second identifying unit shown in FIG. 4 according to an exemplary embodiment of the present invention;

FIG. 7 is a flowchart of a method of identifying an image forming print medium according to an exemplary embodiment of the present invention;

FIG. 8 is a flowchart illustrating step 300 shown in FIG. 7 according to an exemplary embodiment of the present invention;

FIG. 9 is a flowchart illustrating step 300 shown in FIG. 7 according to an exemplary embodiment of the present invention;

FIG. 10 is a flowchart illustrating step 300 shown in FIG. 7 according to an exemplary embodiment of the present invention;

FIG. 11 is a flowchart illustrating step 300 shown in FIG. 7 according to an exemplary embodiment of the present invention; and

FIG. 12 is a flowchart illustrating step 302 shown in FIG. 7 according to an exemplary embodiment of the present invention.

Throughout the drawings, like reference numerals will be understood to refer to like parts, components and structures.

### DETAILED DESCRIPTION OF EXEMPLARY EMBODIMENTS

Exemplary embodiments of the present invention for identifying an image forming print medium will now be described with reference to the accompanying drawings.

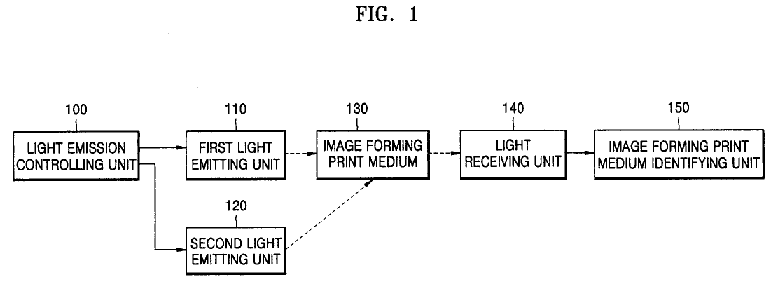

FIG. 1 is a block diagram illustrating a device for identifying an image forming print medium according to an exemplary embodiment of the present invention. The device comprises a light emission controlling unit 100, a first light emitting unit 110, a second light emitting unit 120, an image forming print medium 130, a light receiving unit 140, and an image forming print medium identifying unit 150.

The light emission controlling unit 100 transmits control signals for controlling light emission to the first light emitting unit 110 and the second light emitting unit 120.

When the device is fixed in an image forming apparatus and the image forming print medium 130 passes through the device, the light emission controlling unit 100 controls each of the first light emitting unit 110 and the second light emitting unit 120 to emit light for a predetermined time. That is, the light emission controlling unit 100 controls the first light emitting unit 110 to emit light for a predetermined time, terminates the light emission from the first light emitting unit 110, and then controls the second light emitting unit 120 to emit light for a predetermined time. In addition, the light emission controlling unit 100 controls the second light emitting unit 120 to emit light for a predetermined time, terminates the light emission from the second light emitting unit 120, and then controls the first light emitting unit 120 to emit light for a predetermined time.

On the other hand, when the identifying device is installed in a moving carriage (not shown) of the image forming apparatus and moves together with the carriage, the light emission controlling unit 100 controls the first light emitting unit 110 and the second light emitting unit 120 to emit light while the carriage reciprocates. That is, the light emission controlling unit 100 controls the first light emitting unit 110 and the second light emitting unit 120 so that the first light emitting unit 110 emits light while the carriage moves in a main scan direction, and then the second light emitting unit 120 emits light while the carriage returns to its original location. Alternatively, the light emission controlling unit 100 may control the first light emitting unit 110 and the second light emitting unit 120 so that the second light emitting unit 120 emits light while the carriage moves in the main scan direction, and then the first light emitting unit 110 emits light while the carriage returns to its original location.

The first light emitting unit 110 irradiates light onto the image forming print medium 130 at a first incident angle in response to the control signal of the light emission controlling unit 100. The first light emitting unit 110 uses a light emitting diode as a light emitting element.

The angle between the first light emitting unit 110 and the image forming print medium 130 (the first incident angle) is in the range of about 60 degrees to 90 degrees.

The second light emitting unit 120 irradiates light onto the image forming print medium 130 at a second incident angle in response to the control signal of the light emission controlling unit 100. The second light emitting unit 120 uses a light emitting diode as a light emitting element.

The angle between the second light emitting unit 120 and the image forming print medium 130 (the second incident angle) is in the range of about 30 degrees to 60 degrees.

The light receiving unit 140 receives the light irradiated from the first light emitting unit 110 and the second light emitting unit 120 and reflected from the image forming print medium 130, and transmits the received reflected light to the image forming print medium identifying unit 150. The light receiving unit 140 uses a photodiode as a light receiving element.

The light receiving unit 140 is located at an angle which allows it to receive light which is irradiated at the first incident angle and totally reflected from the image forming print medium 130.

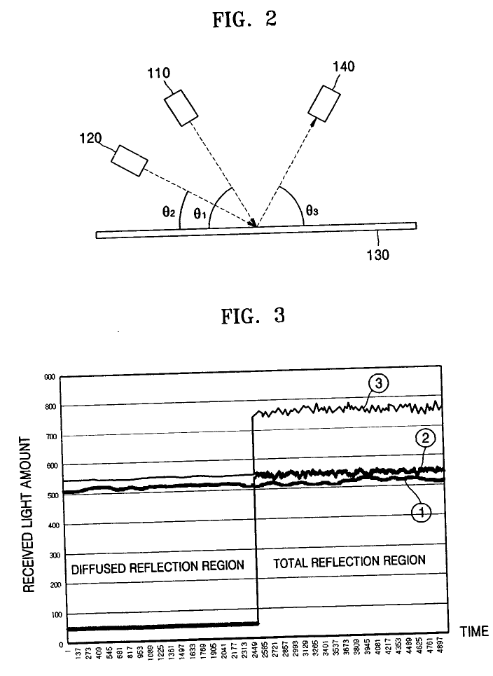

FIG. 2 is a diagram illustrating angles between the surface of the image forming print medium 130 and the first light emitting unit 110, the second light emitting element 120, and the light receiving element 140 in FIG. 1 according to an exemplary embodiment of the present invention.

Referring to FIG. 2, the first light emitting unit 110 forms a first incident angle θ1 with respect to the image forming print medium 130, the second light emitting unit 120 forms a second incident angle θ2 with respect to the image forming print medium 130, and the light receiving unit 140 forms an angle θ3 with respect to the image forming print medium 130.

In this case, the angle θ1 is substantially equal to the angle θ3. This is because the light receiving unit 140 can receive the light which is irradiated from the first light emitting unit 110 and totally reflected from the imaging forming print medium 130 when the angle between the first light emitting unit 110 and the image forming print medium 130 is equal to the angle between the light receiving unit 140 and the image forming print medium 130.

Since the angle between the light receiving unit 140 and the image forming print medium 130 differs from the angle between the second light emitting unit 120 and the image forming print medium 130, the light receiving unit 140 receives light which is irradiated from the second light emitting unit 120 and diffusely reflected from the image forming print medium 130.

FIG. 3 a schematic diagram illustrating the amounts of light received by the light receiving unit 140 for a predetermined duration according to an exemplary embodiment of the present invention.

In FIG. 3, a line graph \textcircled{1} represents the amounts of light received from a total reflection region and a diffused reflection region of the image forming print medium 130 when the image forming print medium 130 is normal paper, such as non-thermal or non-glossy paper, or inkjet paper. The amounts of light which is reflected from the normal paper or the inkjet paper and received by the light receiving unit 140 are almost not different between the total reflection region and the diffused reflection region.

In FIG. 3, a line graph \textcircled{2} represents the amounts of light received in the total reflection region and the diffused reflection region of the image forming print medium 130 when the image forming print medium 130 is transparent paper. The amounts of light which is reflected from the transparent paper and received from the light receiving unit 140 are different between the total reflection region and the diffused reflection region.

In FIG. 3, a line graph \textcircled{3} represents the amounts of light received from the total reflection region and the diffused reflection region of the image forming print medium 130 when the image forming print medium 130 is photo paper. The amounts of light which is reflected from the photo paper and received by the light receiving unit 140 are greatly different between the total reflection region and the diffused reflection region. Regarding total reflection, reflection is predominant to transmission, so that the amount of light received from the total reflection region is relatively large. In addition, regarding diffused reflection, transmission is predominant to reflection and the amount of light received from the diffused reflection region is relatively small.

The image forming print medium identifying unit 150 identifies the kind of the image forming print medium 130 by using the variances of first and second amounts of light received in the light receiving region 140 with respect to time.

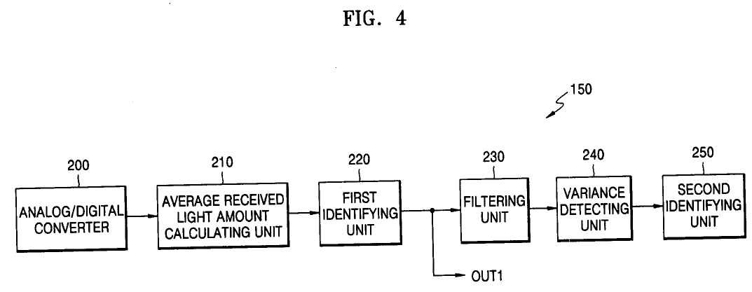

FIG. 4 is a block diagram illustrating the image forming print medium identifying unit 150 shown in FIG. 1 according to an exemplary embodiment of the present invention. The image forming print medium identifying unit 150 comprises an analog/digital converter 200, an average light received amount calculating unit 210, a first identifying unit 220, a filtering unit 230, a variance detecting unit 240, and a second identifying unit 250.

The analog/digital converter 200 converts the first received light amounts and the second received light amounts which have varied for a predetermined duration into digital signals and transmits the converted results to the average received light amount calculating unit 210.

The average received light amount calculating unit 210 averages the first received light amounts and transmits the averaged results to the first identifying unit 220, and the average received light amount calculating unit 210 averages the second received light amounts and transmits the averaged results to the first identifying unit 220.The average received light amount calculating unit 210 calculates the average of the received light amounts for a predetermined time using digital information on the received light amounts for the predetermined time.

The first identifying unit 220 identifies the image forming print medium 130 using the ratio of a first average obtained by averaging the first received light amounts to a second average obtained by averaging the second received light amounts. For example, the difference between the first average and the second average can be obtained using Equation 1.
Ratio between averages=(first average/second average)×1000 Equation 1

Here, “1000” is a constant which makes the ratio of the first average to the second average great, which can be varied.

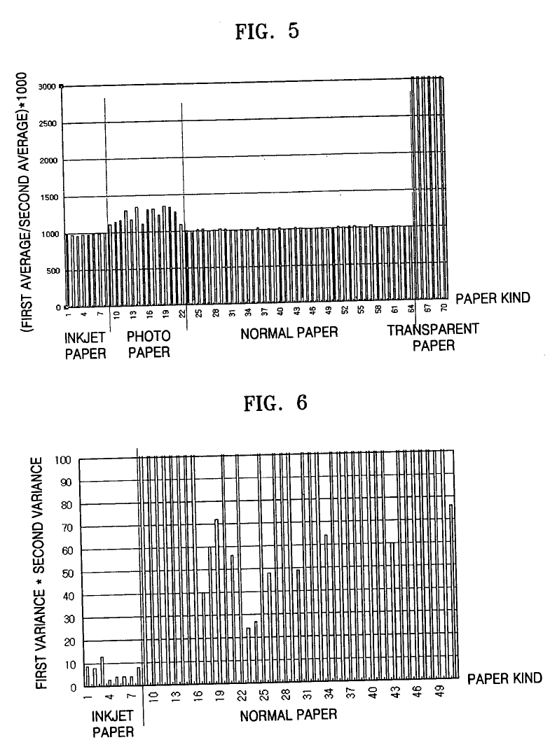

FIG. 5 is a diagram illustrating various kinds of image forming print media identified in the first identifying unit 220 shown in FIG. 4 according to an exemplary embodiment of the present invention.

The ratio of the first average to the second average of each of the image forming print media calculated by using Equation 1 is shown in FIG. 5. Since inkjet paper, normal paper, transparent paper, and photo paper have different ratios between the averages, the image forming print media can be identified. However, since inkjet paper and normal paper have similar ratios between the averages, they can be discriminated from one another using the filtering unit 230, the variance detecting unit 240, and the second identifying unit 250.

When the identified image forming print medium 130 is photo paper or transparent paper, the first identifying unit 220 transmits the identified result to an output terminal OUT1. However, when the identified image forming print medium 130 is normal paper or inkjet paper, the first identifying unit 220 transmits the identified result to the filtering unit 230.

The filtering unit 230 filters the first received light amounts and the second received light amounts in a predetermined frequency range, in response to the identified result of the first identifying unit 220, and transmits the filtered results to the variance calculating unit 240.

The fluctuation of frequency components in a predetermined frequency range is smaller in inkjet paper than in normal paper. This is because a coated image forming print medium, such as inkjet paper, undergoes a relatively small surface characteristic variation due to the coating.

A frequency range in which a difference in received light amount between inkjet paper and normal paper can be recognized is previously detected as the predetermined frequency range and is stored in the filtering unit 230 as filtering information.

The filtering unit 230 band-pass filters a frequency range out of the predetermined frequency range to calculate only the received light amount in the predetermined frequency range.

The variance detecting unit 240 detects a first variance of the first received light amounts and a second variance of the second received light amounts.

The variance is a value which represents the difference between the received light amounts and the average. The variance detecting unit 240 detects the first variance of the filtered first received light amounts and the second variance of the filtered second received light amounts and outputs the detected results to the second identifying unit 250.

The second identifying unit 250 identifies the image forming print medium 130 by using the first variance and the second variance. For example, the second identifying unit 250 multiplies the first variance by the second variance and determines that the image forming print medium 130 is normal paper when the multiplied result is relatively large, and the image forming print medium 130 is inkjet paper when the multiplied result is relatively small. Although the image forming print medium 130 is identified by multiplying the first variance by the second variance, this is only an example. The first variance and the second variance may be used as separate values for identifying the image forming print medium 130.

FIG. 6 is a diagram illustrating the kind of image forming print medium 130 identified by the second identifying unit 250 shown in FIG. 4 according to an exemplary embodiment of the present invention. The reason why the product of the first variance and the second variance of the inkjet paper is relatively small is because the fluctuation of the frequency in the predetermined frequency range is relatively small for the inkjet paper and thus the first variance and the second variance are relatively small. On the other hand, the reason why the product of the first variance and the second variance of the normal paper is relatively large is because the fluctuation of the frequency in the predetermined frequency range is relatively large for the normal paper and thus the first variance and the second variance are relatively large.

The method for identifying the image forming print medium according to the present invention will now be described with reference to the accompanying drawings.

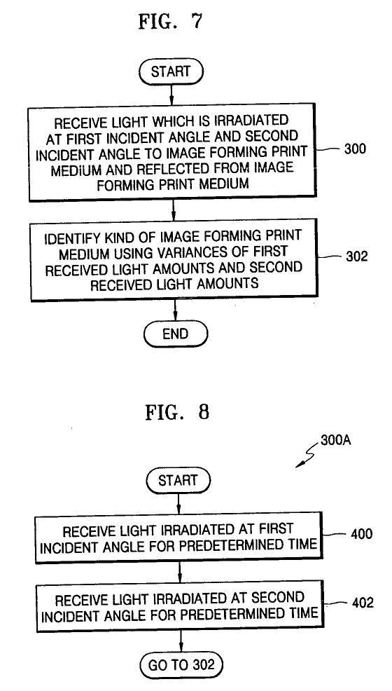

FIG. 7 is a flowchart illustrating a method of identifying an image forming print medium according to an exemplary embodiment of the present invention.

First, light is irradiated onto the image forming print medium at a first incident angle and a second incident angle, and the light reflected from the image forming print medium is received at step 300.

The first incident angle is in the range of 60 degrees to 90 degrees.

The second incident angle is in the range of 30 degrees to 60 degrees.

The light irradiated at the first incident angle can be received at an angle at which total reflection occurs at the image forming print medium.

Referring to FIG. 2, the angle between the first light emitting unit 110 and the image forming print medium 130 is the first incident angle θ1, the angle between the second light emitting unit 120 and the image forming print medium 130 is the second incident angle θ2, and the angle between the light receiving unit 140 and the image forming print medium 130 is an angle θ3. In this case, the angle θ1 is substantially equal to the angle θ3.

FIG. 8 is a flowchart illustrating an exemplary embodiment 300A of step 300 shown in FIG. 7 according to an exemplary embodiment of the present invention. This embodiment is applied when the device for identifying an image forming print medium is fixed in the image forming apparatus, and the image forming print medium 130 passes through the device for identifying an image forming print medium.

First, the light irradiated at the first incident angle is received for a predetermined time at step 400. When the light irradiated from the first light emitting unit 110 is reflected from the image forming print medium 130, the light receiving unit 140 receives the reflected light.

Thereafter, the light irradiated at the second incident angle is received for a predetermined time at step 402. When the light irradiated from the second light emitting unit 120 is reflected from the image forming print medium 130, the light receiving unit 140 receives the reflected light.

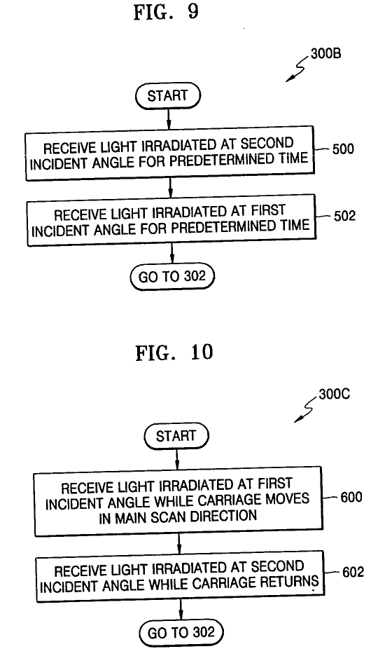

FIG. 9 is a flowchart illustrating an exemplary embodiment 300B of step 300 shown in FIG. 7 according to an exemplary embodiment of the present invention. This embodiment is applied when the device for identifying an image forming print medium is fixed in the image forming apparatus, and the image forming print medium 130 passes through the device for identifying the image forming print medium.

First, the light irradiated at the second incident angle is received for a predetermined time at step 500. When the light irradiated from the second light emitting unit 120 is reflected from the image forming print medium 130, the light receiving unit 140 receives the reflected light.

Thereafter, the light irradiated at the first incident angle is received for a predetermined time at step 502. When the light irradiated from the first light emitting unit 110 is reflected from the image forming print medium 130, the light receiving unit 140 receives the reflected light.

FIG. 10 is a flowchart illustrating an exemplary embodiment 300C of step 300 shown in FIG. 7 according to an exemplary embodiment of the present invention. This embodiment is applied when the device for identifying the image forming print medium is installed in a carriage (not shown) of the image forming apparatus and moves together with the carriage.

First, the light irradiated at the first incident angle is received while the carriage of the image forming apparatus moves in a main scan direction at step 600. When the light irradiated from the first light emitting unit 110 is reflected from the image forming print medium 130, the light receiving unit 140 receives the reflected light while the carriage of the image forming apparatus moves in the main scan direction.

Thereafter, the light irradiated at the second incident angle is received while the carriage returns at step 602. When the light irradiated from the second light emitting unit 120 is reflected from the image forming print medium 130, the light receiving unit 140 receives the reflected light while the carriage of the image forming apparatus returns to its original location.

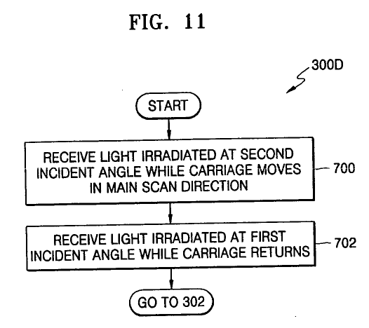

FIG. 11 is a flowchart illustrating an exemplary embodiment 300D of step 300 shown in FIG. 7 according to an exemplary embodiment of the present invention. This embodiment is applied when the device for identifying the image forming print medium is installed in the carriage (not shown) of the image forming apparatus and moves together with the carriage.

First, the light irradiated at the second incident angle is received while the carriage of the image forming apparatus moves in the main scan direction at step 700. When the light irradiated from the second light emitting unit 120 is reflected from the image forming print medium 130, the light receiving unit 140 receives the reflected light while the carriage of the image forming apparatus moves in the main scan direction.

Thereafter, the light irradiated at the first incident angle is received while the carriage returns at step 702. When the light irradiated from the first light emitting unit 110 is reflected from the image forming print medium 130, the light receiving unit 140 receives the reflected light while the carriage of the image forming apparatus returns to its original location.

After operation 300, the kind of the image forming print medium is identified by using the variances of the first received light amounts and the second received light amounts which have varied over time at step 302.

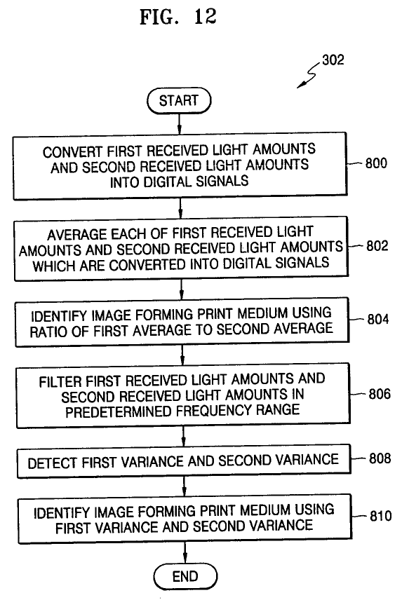

FIG. 12 is a flowchart illustrating step 302 shown in FIG. 7 according to an exemplary embodiment of the present invention.

First, the first received light amounts and the second received light amounts which have varied over time are converted into digital signals at step 800.

Next, the first received light amounts which are converted into the digital signals are averaged and the second received light amounts which are converted into the digital signals are averaged at step 802. The first received light amounts and the second received light amounts which are received for a predetermined duration are respectively averaged.

Subsequently, the image forming print medium is identified by using the ratio of the first average of the first received light amounts to the second average of the second received light amounts at step 804.

Referring to FIG. 5, since inkjet paper, normal paper, transparent paper, and photo paper have different ratios between the averages, the image forming print media can be identified. However, since inkjet paper and normal paper have similar ratios between the averages and cannot be discriminated from one another, operations 806 through 810 are performed to identify them.

The first received light amounts and the second received light amounts which have varied over time are filtered in the predetermined frequency range at step 806.

A frequency range in which a difference in received light amount between inkjet paper and normal paper can be recognized is previously detected as the predetermined frequency range, and a frequency range out of the predetermined frequency range is band-pass filtered to calculate the received light amounts only in the predetermined frequency range.

Next, the first variance of the filtered first received light amounts and the second variance of the filtered second received light amounts are detected at step 808.

Subsequently, the image forming print medium is identified by using the first variance and the second variance at step 810. Since the product of the first variance and the second variance of inkjet paper is relatively small and the product of the first variance and the second variance of normal paper is relatively large, the kind of image forming print medium can be identified by using the first variance and the second variance.

As mentioned above, the device and method for identifying the image forming print medium according to the present invention can accurately identify the kind of image forming print medium used in the image forming apparatus and thus the image forming quality can be improved.

Particularly, since the kind of image forming print medium can be identified by using two light emitting elements and one light receiving element, the cost of the device for identifying the image forming print medium can be reduced.

Further, by filtering the results detected by the light receiving element, the inkjet paper and the normal paper can be accurately identified.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A device for identifying an image forming print medium, comprising:
a first light emitting unit for irradiating light onto the image forming print medium at a first incident angle;
a second light emitting unit for irradiating light onto the image forming print medium at a second incident angle;
a light receiving unit for receiving light which is irradiated from the first light emitting unit and the second light emitting unit and reflected from the image forming print medium;
an image forming print medium identifying unit for identifying the kind of the image forming print medium by using the variances of first received light amounts and second received light amounts which have varied over time; and
a light emission controlling unit for controlling the light emission of the first light emitting unit and the second light emitting unit.

2. The device according to claim 1, wherein the first incident angle is the angle between the first light emitting unit and the image forming print medium and is in the range of about 60 degrees to 90 degrees.

3. The device according to claim 1, wherein the second incident angle is the angle between the second light emitting unit and the image forming print medium and is in the range of about 30 degrees to 60 degrees.

4. The device according to claim 1, wherein the light receiving unit is located at an angle at which the light irradiated at the first incident angle is totally reflected from the image forming print medium.

5. The device according to claim 1, wherein the image forming print medium identifying unit comprises:
an analog/digital converter for converting the first received light amounts and the second received light amounts which are changed over time into digital signals;
an average received light amount calculating unit for averaging the first received light amounts which are converted into the digital signals in the analog/digital converter and which averages the second received light amounts which are converted into the digital signals in the analog/digital converter;
a first identifying unit for identifying the image forming print medium by using the ratio of a first average of the first received light amounts to a second average of the second received light amounts;
a filtering unit for filtering the first received light amounts and the second received light amounts which have varied over time in a predetermined frequency range in response to the identified results of the first identifying unit;
a variance detecting unit for detecting a first variance of the filtered first received light amounts and a second variance of the filtered second received light amounts; and
a second identifying unit for identifying the image forming print medium by using the first variance and the second variance.

6. The device according to claim 5, wherein the filtering unit performs filtering by using a frequency range in which a difference in received light amount between inkjet paper and normal paper can be recognized as the predetermined frequency range.

7. The device according to claim 1, wherein, when the device for identifying the image forming print medium is fixed in an image forming apparatus and the image forming print medium passes through the device for identifying the image forming print medium, the light emission controlling unit controls the first light emitting unit and the second light emitting unit to emit light for a predetermined time.

8. The device according to claim 1, wherein, when the device for identifying the image forming print medium is installed in a carriage, the light emission controlling unit controls the first light emitting unit and the second light emitting unit to emit light while the carriage reciprocates.

9. A method of identifying an image forming print medium, comprising:
(a) irradiating light onto the image forming print medium at a first incident angle and a second incident angle and receiving the light reflected from the image forming print medium; and
(b) identifying the kind of the image forming print medium by using the variances of first light receiving amounts and second light receiving amounts.

10. The method according to claim 9, wherein the first incident angle is in the range of about 60 degrees to 90 degrees.

11. The method according to claim 9, wherein the second incident angle is in the range of about 30 degrees to 60 degrees.

12. The method according to claim 9, wherein (a) irradiating step comprises receiving the light irradiated at the first incident angle at an angle at which total reflector occurs in the image forming print medium.

13. The method according to claim 9, wherein (a) irradiating step comprises:
(a1) receiving the light irradiated at the first incident angle for a predetermined time; and
(a2) receiving the light irradiated at the second incident angle for the predetermined time.

14. The method according to claim 9, wherein (a) irradiating step comprises:
(a1) receiving the light irradiated at the second incident angle for a predetermined time; and
(a2) receiving the light irradiated at the first incident angle for the predetermined time.

15. The method according to claim 9, wherein (a) irradiating step comprises:
(a1) receiving the light irradiated at the first incident angle while a carriage of an image forming apparatus moves in a main scan direction; and
(a2) receiving the light irradiated at the second incident angle while the carriage returns.

16. The method according to claim 9, wherein (a) irradiating step comprises:
(a1) receiving the light irradiated at the second incident angle while a carriage of an image forming apparatus moves in a main scan direction; and
(a2) receiving the light irradiated at the first incident angle for while the carriage returns.

17. The method according to claim 9, wherein (b) identifying step comprises:
(b1) converting the first light emitting amounts and the second light emitting amounts which have varied over time into digital signals;
(b2) averaging the first received light amounts which have varied into the digital signals and averaging the second received light amounts which have varied into the digital signals;
(b3) identifying the image forming print medium by using the ratio of a first average of the first received light amounts to a second average of the second received light amounts;
(b4) filtering the first received light amounts and the second received light amounts which have varied over time in a predetermined frequency range;
(b5) detecting a first variance of the filtered first received light amounts and a second variance of the filtered second received light amounts; and
(b6) identifying the image forming print medium by using the first variance and the second variance.

18. The method according to claim 17, wherein (b4) filtering step comprises performing filtering by using a frequency range in which a difference in received light amount between inkjet paper and normal paper can be recognized as the predetermined frequency range.
